(19) United States
(12) Patent Application Publication
(10) Pub. No.: US 2002/0004729 A1
(43) Pub. Date: Jan. 10, 2002

(54) Electronic data gathering for emergency medical services

(76) Inventors: Christopher Zak, Hamburg, NY (US); Thomas F. D'Aprix JR., Buffalo, NY (US); Anthony J. Billitier, Lancaster, NY (US)

Correspondence Address: JAECKLE FLEISCHMANN & MUGEL. LLP, 39 State Street, Rochester, NY, 14614-1310, US

(21) Appl. No.: 09/842,449

(22) Filed: Apr. 26, 2001

Related U.S. Application Data
(60) Provisional application No. 60/199,871, filed on Apr. 26, 2000.

(51) Int. Cl. G06F 17/60

(52) U.S. Cl. 705/3

(57) ABSTRACT

An apparatus for capturing and storing medical emergency information under the adverse circumstances of the emergency scene, without relying on multiple computers and remote communications for support during use. To accomplish data capture and storage, use of a single ruggedized hand held computer with a graphical user interface employing a touch sensitive display screen, and pen stylus for simplifying documentation of patient demographic, history and medications data, focal patient complaints and problems, vital signs, physical exam findings, medication administration, routes and quantities, motorized vehicle crash history, case disposition, emergency crew, and case review and notes. Collection of focal patient complaints and problems is simplified through a body graphical user interface. Easily accessed reference databases for drugs and protocols support the emergency medical technician. Handwriting recognition, signature capture and numerical data entry enable obtaining of necessary crew and patient signatures and other data, including patient refusal of care. Through the use of a variety of secure communication interfaces, printing or transfer of all data collected is provided to other systems. Full compliance with NHTSA and Utstein minimal data reporting set requirements.

### CROSS-REFERENCE TO RELATED APPLICATIONS

This application claims the benefit of U.S. Provisional Patent Application Ser. No. 60/199,871, filed Apr. 26, 2001, (Attorney Docket No. 89283.041200).

### FIELD OF INVENTION

This invention relates to systems for the gathering and storing of data, and more specifically to systems for gathering and storing emergency medical services data.

### DEFINITIONS

### DISCUSSION OF PRIOR ART

Much research is focused on reducing transportation-related deaths and disabilities through research, development, testing, and evaluation of advanced technologies and systems for the prevention and emergency treatment of crash injuries. The collection of timely and accurate data from motor vehicle crashes (MVC) is vital to this research process.

Efficient real-time collection of data from emergency medical services (EMS) personnel is essential. Most states have manual systems for collecting out-of-hospital care data, including EMS information. These systems are prone to inaccuracies, lack standardization, and frequently fail to provide data in a timely manner for analysis.

Many states utilize paper reporting systems to collect out-of-hospital data. Emergency medical technicians (EMTs) may use carbonless pre-hospital care records (PCR) to document patient care. Such forms are issued by state health departments, and use both free form text fields and check boxes.

PCR data follow many paths. For example, in the state of New York, if a patient is transported to a hospital, one copy of the PCR is left at the receiving hospital with the patient for inclusion in his/her medical record. The emergency service provider agency retains a second copy of the PCR. The regional EMS coordination agency receives the third copy. Upon receipt of the PCR, the regional EMS coordination agency scans for completion of required data fields and forwards it to a New York State Department of Health vendor, which manually enters this information into a computerized database.

PCR copies may be faint, illegible or incorrectly filled out. Data entry personnel working with such copies are likely to introduce errors into the data. Once the data entry process has been completed, the data for each region is placed on a CD-ROM and sent back to the appropriate regional EMS coordination agency on an annual basis. A regional medical advisory committee may use this limited data set for quality improvement and research purposes.

Commercially-available, off-the-shelf automated products have been developed to address the deficiencies of manual EMS data collection reporting systems, but these products suffer from significant disadvantages:

High cost—Current EMS data collection systems are expensive, typically costing $5,000 to $10,000 per field unit. The available commercial systems typically utilize large, costly general-purpose Windows 95/98/NT computers.

Incompleteness—Current systems cannot assemble a complete medical record. Some existing systems utilize a minimal data set. They do not collect enough information to accurately reflect all important findings of the out of hospital care providers.

Inflexibility—Current systems cannot customize software as needed. Future research and support requirements for emergency services will most likely require the collection of additional data elements. To facilitate such added collection, the data collection device must be re-programmable. In existing systems, it is both difficult and expensive to alter commercial software to meet evolving data collection requirements.

Difficulty of use—A salient weakness of current systems is their lack of a simple, intuitive user interface. Many EMS service providers are volunteers who have limited time for training. The acceptance and success of any system in this situation depends upon a friendly, simple and efficient user interface. Such an interface has not been available.

Lack of focus—Current systems lack medically focused complaint driven data entry screens. Most commercially available data collection systems use a limited number of generic forms to collect data. Unfortunately, this approach does not help the out-of-hospital care provider (the emergency medical technician) to collect focused, medically pertinent information on a case.

U.S. Pat. No. 6,117,073 (Jones et al.) teaches the use of a set of computers and computer programs to implement an integrated medical database system for the emergency medical transportation business. The Jones patent describes a clinical and diagnosis computer for on-the-scene treatment, a dispatch computer for selecting and routing emergency transport, an administration computer, a billing computer, and a database server computer for managing all communications among the various computers and providing database access for statistics and trauma records.

This system suffers from all the critical weaknesses of a system using multiple computers connected remotely to each other. First, it requires a server computer to handle all communications among the software modules in different types of client computers. One type of client computer provides clinical input and diagnosis at the scene. Failure of the server computer effectively cuts off all support to any and all such clients at just the time when such support is vital. Failure of communication links between the server and the clients can have the same effect. Second, the use of multiple computers and intercomputer communications entails considerable cost, not only for the basic hardware and software, but also for overcoming the processing and communication reliability problems just described. Too many EMS organizations are badly cash-strapped, making such a costly system inaccessible. Third, the maintenance and enhancement of a multiple-computer system, with different computers playing different roles, is costly, time-consuming, and error-prone. Finally, the system of the Jones patent fails to address the essential details of a workable user interface, and this is critical for accurate, reliable and timely provision of emergency services in adverse conditions.

U.S. Pat. No. 5,586,024 (Shaibani) teaches the use of a computer system to assist in diagnosing trauma injuries. This system does not provide on-scene support for emergency medical technicians (EMTs), but is used by physicians in emergency rooms. While it records details of a situation resulting in traumatic injury, it requires its user to navigate a large number of different screen menus to complete a record of the situation. Such navigation is time-consuming, and is therefore not suitable for use in on-scene support. The incorporation of database lookups to provide diagnostic support is likewise undesirable in an on-scene system for EMTs. The Shaibani patent does not provide for structured entry of patient complaints, reported symptoms, or billing information.

U.S. Pat. No. 5,088,037 (Battaglia) describes an instructional device for prompting appropriate steps to be taken in any of a variety of emergency medical situations. Except for a record of elapsed time intervals, the Battaglia patent does not address the keeping of information concerning an emergency situation.

U.S. Pat. No. 5,619,991 (Sloane) describes a method for providing diagnosis and treatment via electronic communications between a patient or another entity such as a medical testing center and a physician capable of preparing a diagnosis from the reported perceptions and test results. This method does not address the problems of medical emergency situation data gathering and storage.

### SUMMARY

The invention captures and stores medical emergency information under the adverse circumstances of the emergency scene, without relying on multiple computers and remote communications to support it during use. To accomplish data capture and storage, the invention uses a single ruggedized hand held computer with a graphical user interface employing a touch sensitive display screen, and pen stylus for simplifying documentation of patient demographic, history and medications data, focal patient complaints and problems, vital signs, physical exam findings, medication administration, routes and quantities, motorized vehicle crash history, case disposition, emergency crew, and case review and notes. The invention simplifies the collection of focal patient complaints and problems through a body graphical user interface. To support the emergency medical technician, the invention provides easily accessed reference databases for drugs and protocols. Through its graphical user interface and multilingual presentations, the invention provides handwriting recognition, signature capture and numerical data entry to obtain necessary crew and patient signatures and other data, including patient refusal of care. Through the use of a variety of secure communication interfaces, the invention provides for printing or transfer of all data collected to other systems. The invention complies with NHTSA and Utstein minimal data reporting set requirements.

### DESCRIPTION OF DRAWINGS

FIG. 1 illustrates the flow of electronically collected out-of-hospital care data.

FIG. 2 shows the invention's form for documenting multiple patient complaints.

FIG. 3 shows the “Body GUI” used to document additional patient complaints obtained during the history phase of an EMS call.

FIG. 4 shows how the EMS provider can use the Body GUI to “zoom in” to document finer levels of detail.

FIG. 5 illustrates how information particular to a specific patient complaint is collected.

FIG. 6 shows a form designed specifically for the acquisition of crash-related data.

FIG. 7 shows a second form designed specifically for the acquisition of crash-related data.

FIG. 8 shows the invention's form for capturing the specifics of an EMS call.

FIG. 8a shows a time entry component of a form.

FIG. 9 illustrates how treatment options are logically grouped for easy data entry.

FIG. 10 shows the invention's form for documenting vital signs.

FIG. 11 shows a billing form used to capture all necessary reimbursement information.

FIG. 12 shows the navigation portion of a typical form.

### DETAILED DESCRIPTION OF INVENTION

The invention provides EMS agencies with a cost-effective tool to collect accurate, timely, and standardized data. It also provides EMS personnel with a compact, convenient, durable, and inexpensive device that strongly supports their efforts to provide quality out-of-hospital care.

During an emergency call, the emergency medical technicians (EMTs) have very little time to spend on entering data into a computer system. They are confronted with a large array of sophisticated medical equipment to be used in a medical crisis, when every second and every movement counts, and the medical problem confronting them contains many unknowns requiring fast, accurate and effective analysis and response centered on the patient. Consequently, the fewer movements and steps an EMT must add to the process for data gathering, the safer, faster and more effective the response will be. The invention addresses this problem by radically simplifying the user interface for gathering complex emergency data.

As noted earlier, existing systems typically cost $5,000 to $10,000 per field unit. The available commercial systems typically utilize expensive Windows 95/98/NT computers. By contrast, the invention uses new rugged, hand-held computing devices, such as the Hitachi HPW630ETR, configured with compact, well-known operating systems such as Windows CE, thereby significantly reducing hardware and software costs. The invention provides for reprogramming of the hand-held device to collect additional data elements as requirements change.

The invention uses as its data entry method a pen or stylus (pen stylus) with a touch-sensitive screen instead of a standard computer keyboard and mouse or trackball. This simplifies the EMT's task in entering information, since a keyboard is extremely difficult to manipulate in an emergency situation where physical movement is nearly constant and body positions are rarely supportive of keyboard data entry.

The invention provides a simple, intuitive graphical user interface, ideal for use by volunteer EMS service providers with limited time available for training. This interface facilitates widespread acceptance of the invention. The invention uses forms, presented as individual screens displayed to the user, to gather and display information, and to change the display from one form to another. Each form occupies a single screen display. Where the information of a particular type such as patient problems requires more than one form for its entry, the invention uses multiple forms, each on one screen. To enter data, the EMT points to the desired area, value, button, or check box using a pen stylus pressed against the invention's touch-sensitive screen. The act of pressing the pen stylus on the screen where the desired item is displayed results in the storage of a corresponding data item.

Through the use of carefully-designed forms based on specific patient complaints and exam findings, the invention helps the out-of-hospital care provider (e.g., EMTs) obtain focused, medically pertinent information. The invention's design frees the EMT from collecting unnecessary data. The design is based on information obtained from EMS practitioners. For the invention's design, eleven state EMS directors provided copies of the out-of-hospital data collection forms used in their states, together with their plans for automation of the reporting process. The invention incorporates this information in its design and implementation.

The invention's features include:

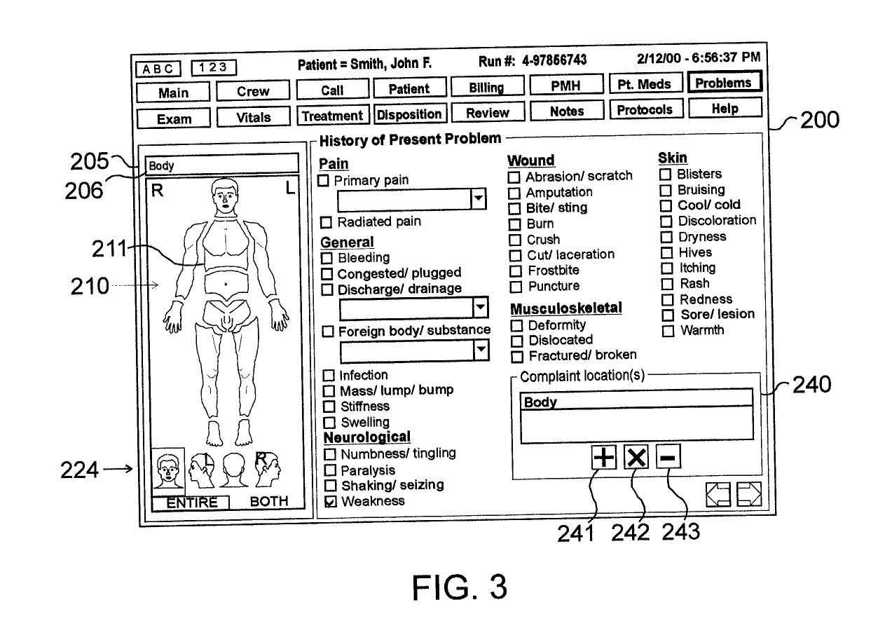

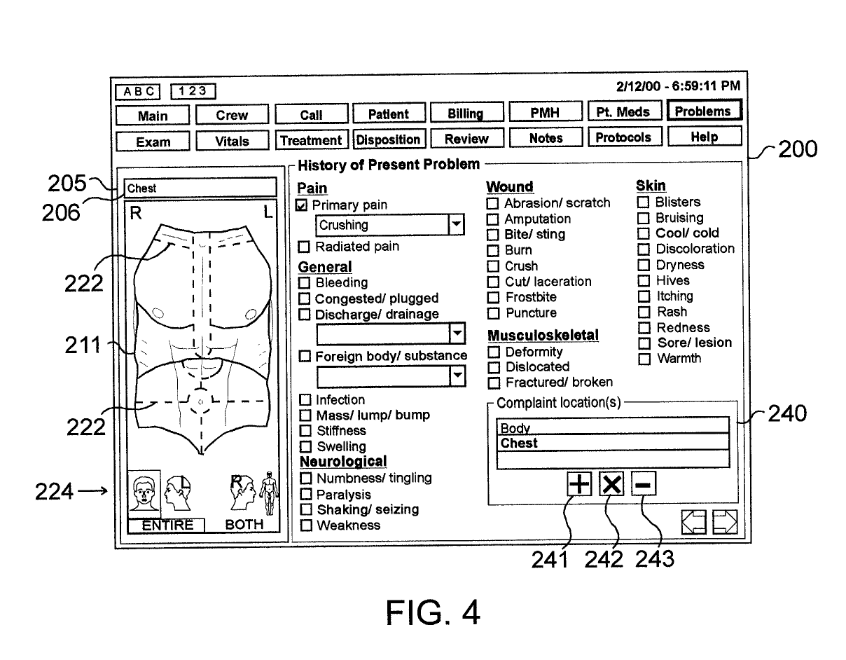

A “Body GUI”, or custom designed, gender specific, body graphical user interface, to simplify documentation of focal patient complaints and physical exam findings (see FIGS. 3 and 4). Note that entry of such complaints and findings is done with the same interface whether the information originates with the patient or with an observer or EMT.

Custom designed “widgets” for handwriting recognition, signature capture and numerical data entry. For data entry, the invention allows the EMT to choose freely between the use of pen stylus and touch screen to choose input values, the use of handwriting recognition software that accepts handwritten characters and numerals, or the use of an attached keyboard.

Quick entry icons for rapid entry of “normal” vital sign and physical exam findings.

Intelligent dynamic drop down pick-lists based upon patient's age.

Multi-lingual forms for documenting a patient's refusal of care.

Integrated signature capture for collection ofrequired patient and crew signatures.

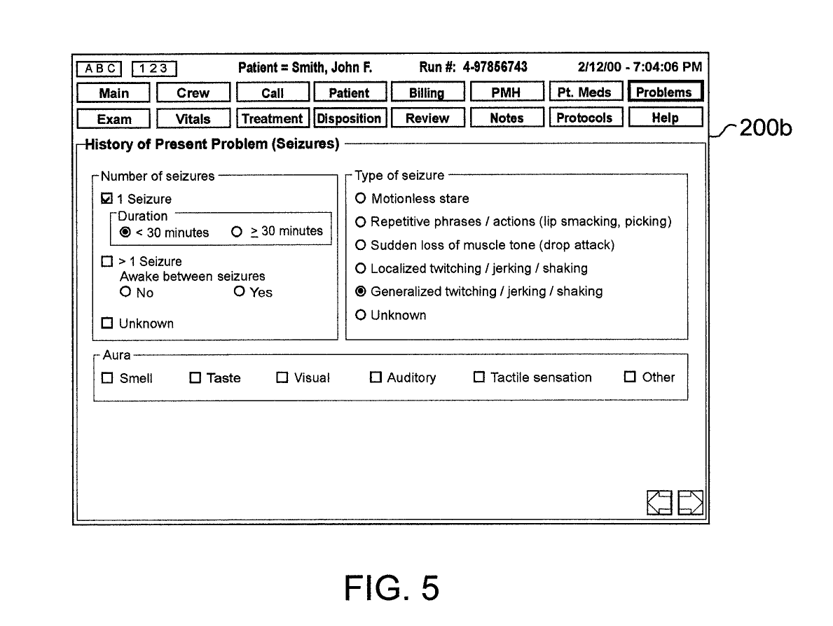

Medically focused complaint- and exam-driven data entry forms (see FIGS. 5, 6 and 7).

Secured data transmission and synchronization via dial-up telephone or TCP/IP connections.

Integrated drug reference guide.

Integrated out-of-hospital care provider protocols.

An intelligent drug treatment form to facilitate rapid documentation of medication administration, routes and quantities.

Ability to upgrade software via dial-up or TCP/IP connections.

Versatile report printing via either wireless infrared transmission ports or standard serial cables to a variety of commonly-used compatible printers.

Inclusion/compliance with NHTSA and Utstein minimal data reporting sets.

The invention provides a complete medical record, and collects enough information to reflect accurately the important findings of the out-of-hospital care providers (e.g., the EMTs).

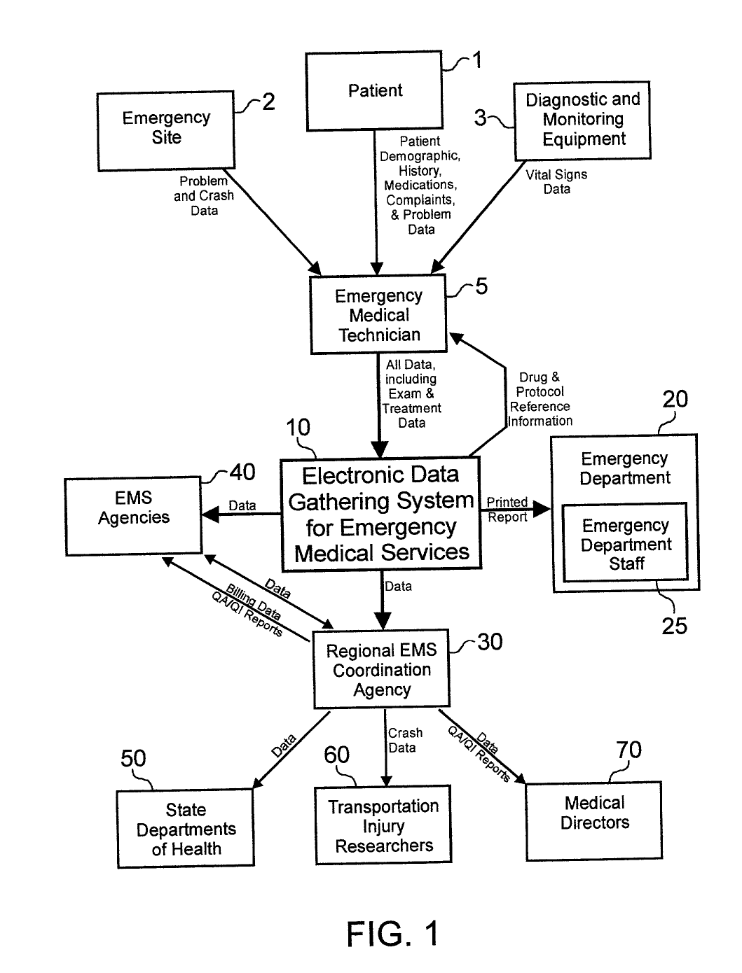

See FIG. 1. The invention 10 is carried by the emergency medical technician 5 (EMT), and collects, transports and disseminates emergency call data. The EMT uses the invention at the site 2 of a medical emergency to collect all patient and site data. While transporting the patient 1 to the hospital, the EMT 5 documents vital signs and physical exam findings, including data from diagnostic and monitoring equipment 3 by storing them in the memory of the invention 10. When the patient 2 is transported to an emergency department 20, the patient care report 15 is wirelessly transmitted to an emergency department laser printer, and the EMT shares patient data collected in the field with emergency department staff 25. After delivering the patient 1 to emergency department staff 25, the EMT 5 finalizes the report in the emergency department 20.

The invention transmits data obtained in the out-of-hospital setting to the regional EMS coordination agency 30 on a periodic basis via dial-up or TCP/IP connections. The invention also provides commercial EMS agencies 40 with copies of the electronic data, in support of their billing and Quality Assurance/Quality Improvement (QA/QI) processes. Finally, a subset of the data is electronically forwarded to the State Department of Health 50 to satisfy its reporting requirements. The regional EMS coordination agency 30 also forwards crash data to transportation injury researchers 60, and sends general data and QA/QI reports to health care system medical directors 70.

The invention includes a set of data collection forms for each aspect of the emergency medical care process. Each form is displayed, when requested, on the hand held computer's touch sensitive screen. Any element of the form, such as a drop down menu, a radio button, a check box, a graphic area, or other data entry area, may be made sensitive to a touch on the screen with a pen stylus. Since the emergency care process frequently requires changes in the order of tasks performed, each form is easily accessible from any other form. The basic set of directly-accessible general forms is:

Main—the introductory form.

Crew—provides for entry of EMS crew information.

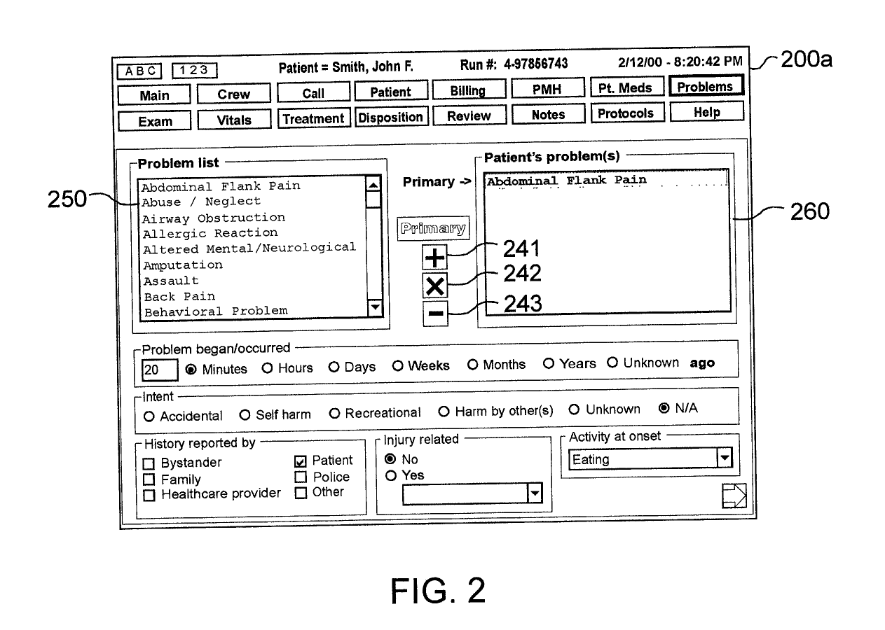

Problems—provides multiple forms for entry of details of the patient problem for which the emergency call was made. See FIGS. 2, 3, 4, 5, 6 and 7 for problem forms 200a, 200, 200, 200b, 200c, and 200d respectively.

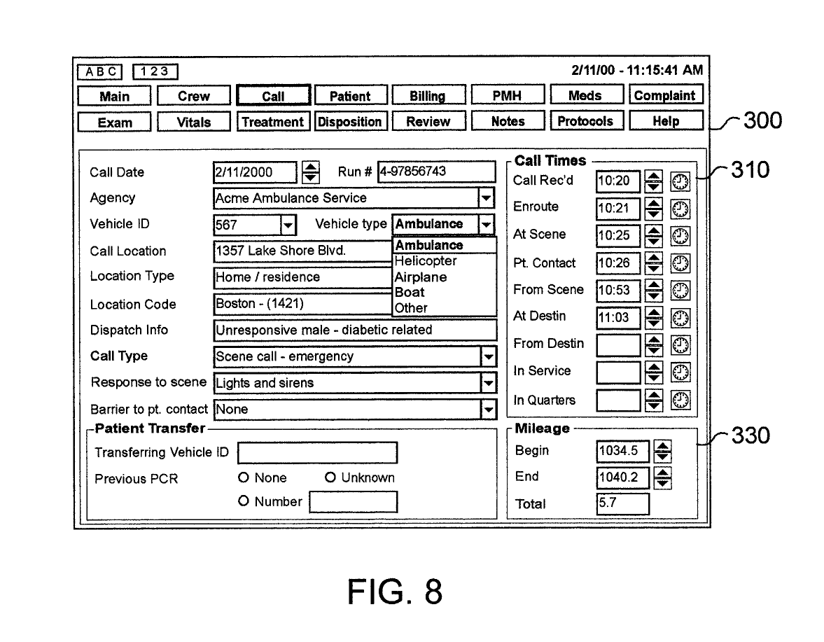

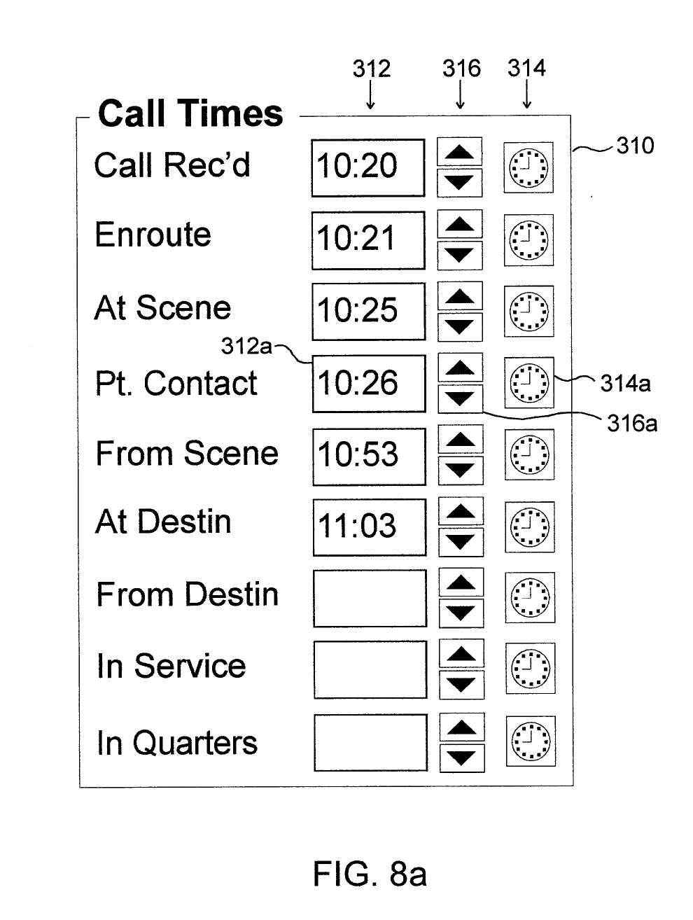

Call—provides for entry of emergency medical call information. See FIG. 8 for call form 300.

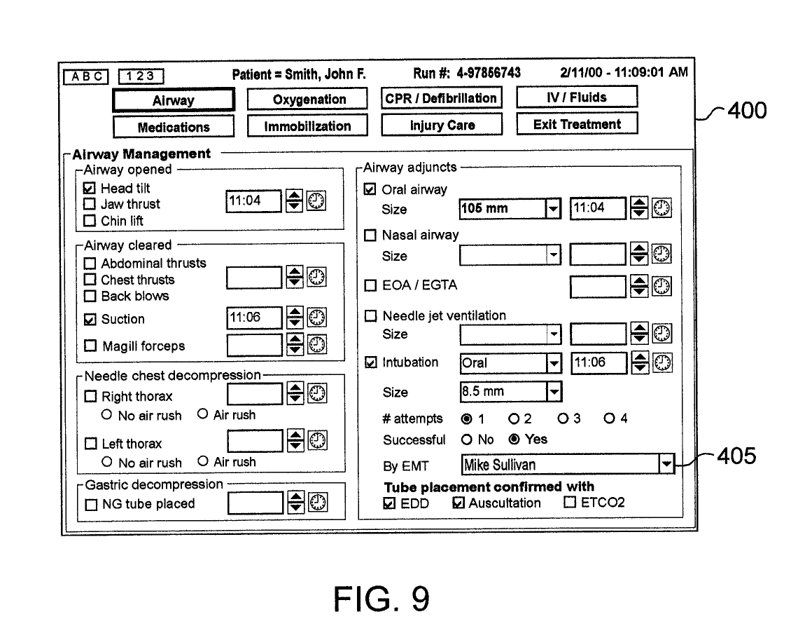

Treatment—provides for entry of patient treatment by EMTs. See FIG. 9 for one of treatment forms 400.

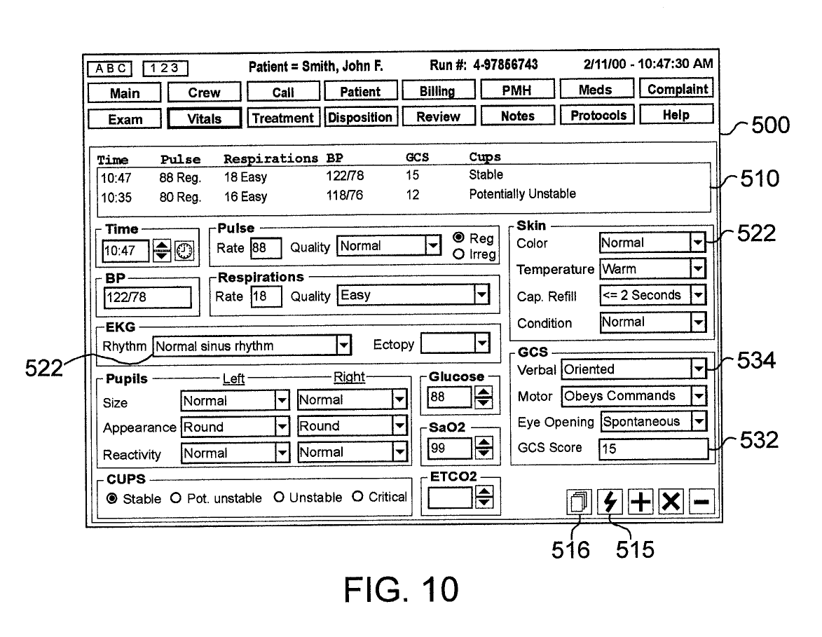

Vitals—provides for entry of patient vital signs. See FIG. 10 for vitals form 500.

Patient—provides for entry of patient demographic information (name, address, gender, etc.) on a call.

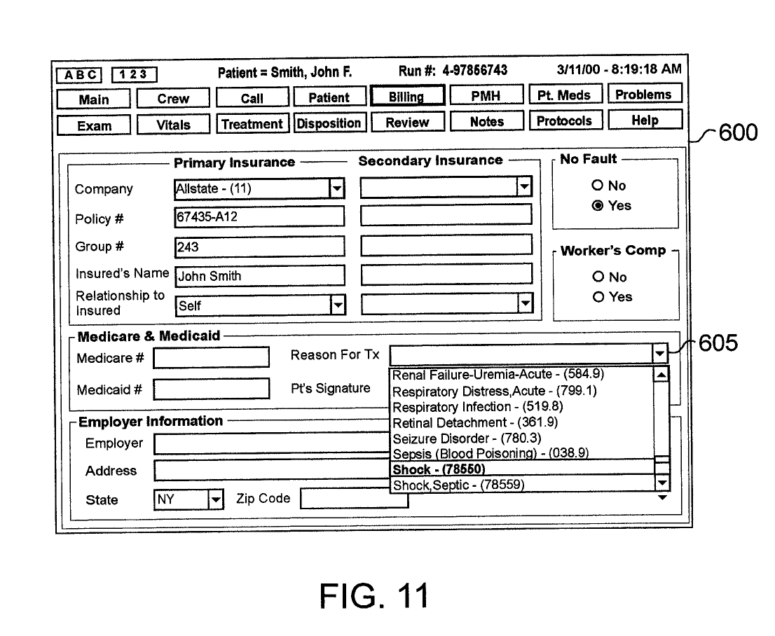

Billing—provides for entry of billing information for the patient. See FIG. 11 for billing form 600.

PMH—provides for entry of patient's past medical history.

Pt. Meds—provides for entry of patient medications.

Exam—provides for entry of patient exam findings

Disposition—provides for entry of information concerning disposition of the call.

Review—provides for entry of review notes regarding the call.

Notes—provides for entry of general notes.

Protocols—provides for retrieval of prehospital care protocols.

Help—provides access to guidance on the use of the invention.

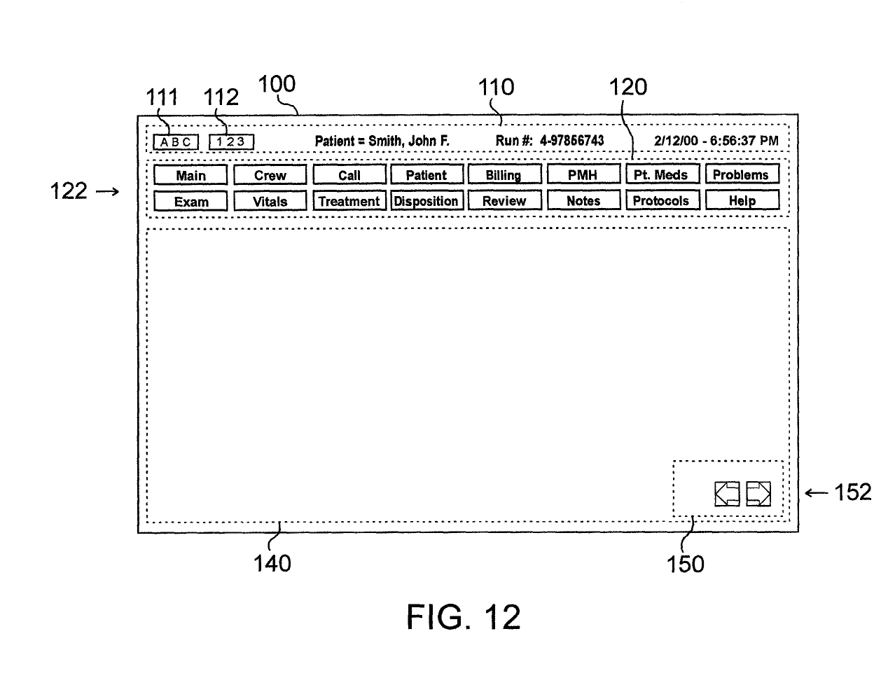

As shown in FIG. 12, general forms are directly accessible via the double row of buttons 122 at the top of each general form. Certain general forms, i.e., the treatment form, are made up of a set of detailed forms. As illustrated in FIG. 9, the treatment form 400 shows the full set of detailed treatment forms as a double row of buttons at the top, replacing the buttons for the general forms. This facilitates navigation among different components of treatment during the actual course of treatment, an advantage when the EMTs are busy with the patient under crisis conditions. Button selection is easily done using the pen stylus on the invention's touch-sensitive screen.

The invention's form design incorporates many data elements on each form, grouped according to their relevance to a given situation. This approach eliminates the need to page through a long series of menu screens to find the data elements which must be entered. See FIG. 12. Each form 100 contains four basic areas for display. At the top of each form is the emergency call header area 110, containing the patient name, emergency vehicle run number, and the current time and date. Header area 110 also contains input control icons 111, 112 for turning off keypad widgets to allow the EMT to use an attached keyboard or handwriting recognition software directly. Below the header area 110 is the form selection area 120, displaying an array of buttons 122, each of which, when selected, causes a specific form to be displayed. Below the form selection area 120 is the form detail area 140, which varies from form to form depending on the information needed from the user. In the lower right of many forms appears a form paging area 150, usually containing one or two arrow icons 152 which allow the EMT to page back and forth through a specific series of forms making up one related set.

FIG. 3 shows a problem form 200 incorporating the invention's “Body GUI” (Body Graphical User Interface) 205 used to document additional patient complaints and exam findings obtained during the history phase of an EMS call. In the body GUI 205 of the problem forms 200, a graphical representation of the human body 210 is shown at the left of the form detail area. By simply touching the display of a particular body part using the pen stylus, the EMT user can easily associate focal patient complaints and exam findings with a particular body region, and “zoom in” to document finer levels of detail in a medical problem. See FIG. 4, which shows the result of selecting the thoracic portion 211 of the body representation 210 in FIG. 3. Dashed lines 222 help the user to identify regions that are selectable, so that the user can zoom in further to the left or right chest, sternum, belly, side, or other marked area. Icons 224 at the bottom of the “Body GUI” allow the user to rotate the image for lateral or posterior views, select right and left body parts (e.g., hands, eyes), or zoom back out to the full body image. The portion of the body being selected appears in text form listed in the Complaint location(s) window 240, and appears as well in a header line at the top of body GUI display 205. The Body GUI is also gender specific based upon the patient's sex as entered on the patient demographics form.

The invention makes extensive use of time-saving and error-resistant graphical user interface tools. See FIG. 8a, which is an enlargement of the call times area 310 of FIG. 8. One of the critical data entry elements in EMS practice is the time stamp, used frequently in the call and treatment forms to document the timing of specific steps in the emergency response. A call time must be logged for each stage of an emergency call. The call times area 310 of the call form 300 provides data entry spaces 312 for these log entries, together with clock icons 314 and up and down arrows 316 next to data entry spaces 312. A single selection (“click” or “touch”) of the clock icon 314a next to a data entry space 312a posts the current time into that space. Use of the up and down arrows 316a adjacent to the space 312a allows the EMT to adjust the posted time entry as required. Both clock icons 314 and arrows 316 may be selected easily in single actions using the pen stylus and the touch-sensitive screen.

A second critical data entry element is the selection of one of a known set of alternatives from a list, eliminating the need for typing or writing of entire phrases of possibly-complex jargon. The invention uses the well-known drop-down menus, radio buttons, and check boxes to offer the EMT a set of choices from which to post data, saving considerable time and effort, and restricting the range of choices to those known to be valid. As before, selection is easily done using the pen stylus with the touch-sensitive screen.

The invention uses quick-entry icons to accomplish frequently-performed tasks with a single movement. The forms in FIGS. 2, 3, and 4 show the use of “+”, “x”, and “−” icons 243. Using the “+” icon adds the currently-designated complaint (or finding) to the complaint list. Using the “x” icon clears the currently-designated complaint and cancels the associated changes. Using the “−” icon deletes a complaint from the complaint list. The form in FIG. 2 (Problem forms 200a) uses the same icons in the same way for the problems list.

As shown above, the entry of text and numeric data using a pen computer interface has been minimized. The forms in FIGS. 2-7 and 9 show only entries which may be made directly by pen or stylus touch, the simplest, fastest, and most error-free method. Numeric data entry is implied in FIG. 10 (Vitals form 500) for pulse, BP, respiration and other items. Text data entry is required in FIG. 11 (Billing form 600) for policy number, group number, insured's name, and other fields, and in FIG. 8 (Call form 300) for call location, dispatch info, and other fields. Such entries are done using a screen-displayed keypad for numbers and/or letters, as appropriate. The user touches the area of data entry with the pen stylus, and the invention displays a touch keypad appropriate for the selected area. The user then enters data by touching the keypad with the pen stylus.

The invention's design allows EMS providers to document multiple patient complaints. See FIG. 2, which shows the initial problem form 200a. EMS providers can select patient complaints from the preformatted list 250 on the left and add them to the list 260 of the patient's problems on the right, thus allowing for multiple patient complaints. Common complaint details such as the time the problem began, activity at onset, and person reporting the history of the illness can be associated with each patient complaint. Subsequent forms displayed are specific to the particular patient complaint being documented. For example, see FIG. 5, showing the seizure problem form 200b which is displayed as a part of the problem form series whenever the highlighted problem on the form shown in FIG. 2 is “Seizure” or an entry carrying a similar meaning.

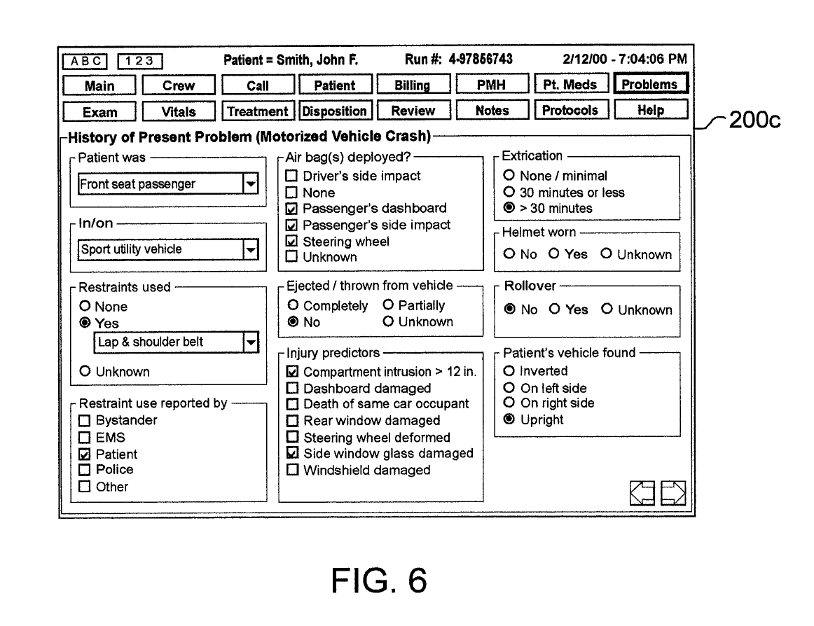

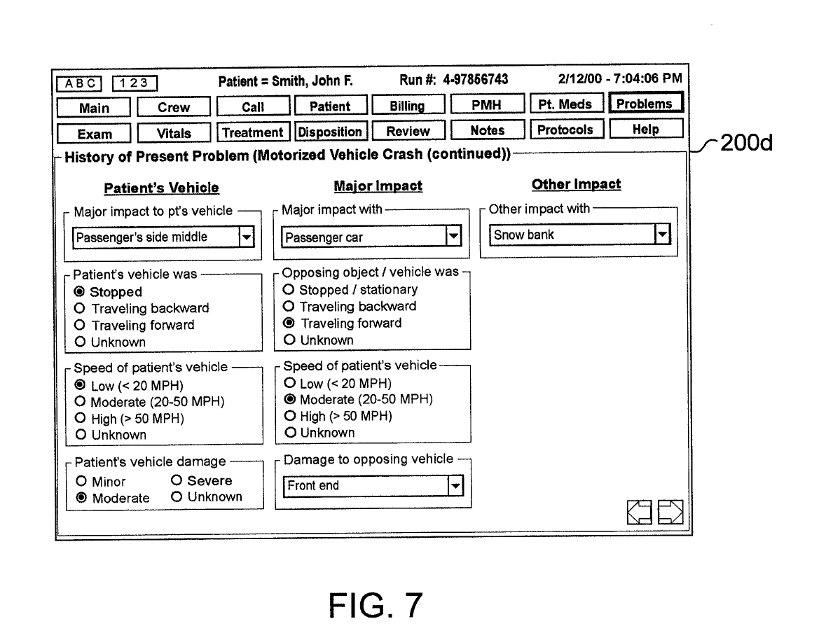

The invention allows EMS providers to gather and retain focused, pertinent crash-related data. FIGS. 6 and 7 are examples of the invention's forms designed specifically for the acquisition of data related to a motor vehicle crash. All information collected using these forms is relevant to injury patterns that patients may experience during such a crash.

In a case where pain or other bodily symptom is reported as shown in FIG. 2, the sequence of forms exemplified in FIGS. 3 and 4 is displayed, so that the Body GUI can be used to narrow down reported symptoms. If the highlighted problem involves a motorized vehicle crash on the FIG. 2 form, the forms 200c and 200d of FIGS. 6 and 7 respectively are displayed as part of the sequence of problem forms to gather crash data. Other crash data forms may be added as needed. In general, by selecting (highlighting) a specific complaint in the problem list, the EMT selects a specific sequence of forms appropriate to the selected entry.

FIG. 5 shows seizure form 200b illustrating how information concerning a specific patient complaint is collected. By combining this specific information with the more general information obtained on other forms, a comprehensive event history can be obtained. Note the ability to use the “next” or “back” arrows to navigate through additional forms pertinent to this particular patient complaint.

FIG. 8 shows the invention's call form 300, used to capture information relevant to the specifics of an EMS call. Call times 310, incident location, and incident numbers are a few of the many items captured on this form. Some of the features evident on this form include quick entry time stamps, increment and decrement arrows for quick data editing, and dropdown pick lists to ensure consistent data entry. Other features include an automatic mileage calculator 330, user customizable dropdown pick lists, and conformity with NHTSA incident reporting standards.

FIG. 10 shows a vital signs form 500 allowing the EMT to document vital signs quickly, in one easily accessible place. A scrolling list box 510 at the top provides EMS providers with the ability to quickly review prior sets of vital signs. A quick entry icon 515 (lightning bolt) allows users to set all vitals signs to a “normal” value to reduce data entry time (note that numeric values must still be entered manually). Also, a “copy previous vital signs” icon 516 (copy) allows users to quickly enter anew set of vital signs by using the previous set of vital signs as a starting point (the user need only make any appropriate changes). Dropdown pick lists 522 allow for quick and consistent data entry while increment and decrement arrows allow for easy data editing. An automatically calculated GCS (Glasgow coma scale) score 532 and GCS dropdown lists 534 that change based upon the patient's age are also features of the vital signs form 500.

FIG. 9 shows the invention's treatment form 400 used to document the treatments given by EMS providers. This form illustrates how treatment options are logically grouped for easy data entry. Time stamps can be associated with each procedure and detailed data can often be selected from dropdown pick lists. For advanced skills, a particular crewmember named in a dropdown list 405 can be credited with performing a skill. The giving of credit assists in the quality assurance/quality improvement process.

FIG. 11 shows the invention's billing form 600, which captures all necessary reimbursement information in one convenient place. To help EMS agencies improve revenue recovery, field providers can document the reason for ambulance transport using a predefined list of ICD-9 codes in a dropdown list 605.

The invention uses well-known programming tools such as Visual Basic in its user interface implementation. Such tools make convenient the everyday changes to the contents of drop-down menus, button bars, and other frequently-used and frequently-changed components. Consequently the invention is easy to maintain and upgrade as EMS practice changes. Such changes are frequent.

The illustration of the invention's forms shown in this specification should not be construed as limiting the invention to these illustrations. The illustrations are presented to show not only examples of the invention's information handling but also the invention's design and implementation. This design and implementation apply to all of the invention's forms and their use, and make the invention achieve its intended purpose: to give the EMT a usable, accurate, inexpensive tool for gathering and distributing EMS call information.

### Operation of Invention

The invention is used in the general manner of the following example. An EMS team begins a shift of service by logging in and providing the crew information for the shift [no—when call is received. But call info auto comes up on next call], using the Crew form. When a call is received, the EMT using the invention begins by logging in and providing the crew information. This information is retained for subsequent calls. The EMT then enters the call information using the Call form (FIG. 8), detailing the call date, run number, agency, call type, vehicle ID and type, call location, mode of response, and all other information available at the time the EMS team is dispatched to the scene of the emergency. The call form provides for entry of times marking different events during the call. The call form is used throughout any call to log these time entries as required. The invention stores all call data for both short-term use by the EMS team and long-term use by other organizations.

On arriving at the emergency scene, the EMT gathers information about the patient and the emergency problem, using the Exam form, the Vitals form (FIG. 10), the Problem forms (FIGS. 2-7), the Pt. Meds (Patient Medications) forms, and the PMH (past medical history) forms. Once the EMS team has decided on a course of treatment and begun to carry it out, the EMT documents the chosen treatment(s) using the Treatment forms (e.g., FIG. 9). By this time the EMS team may be en route with the patient to a hospital or other care facility. At any point during a call, the EMT uses the Billing form (FIG. 11) to obtain and record the appropriate information for billing of the call, and may make additional entries using any of the forms including the Notes form. On arrival at the hospital, the patient is turned over to the emergency department staff, and the EMT logs the disposition of the call using the Disposition form. The Disposition form is also used when a patient refuses treatment or is otherwise released. The invention retains all required information relating to the emergency call in its memory in an XML format, and transfers this information to the emergency department via either a printed report or an electronic transfer to the hospital's computer systems. The invention creates SQL to load/update ODBC-compliant databases, and produces ASCII text files as required by some receiving systems.

The invention supplies important reference data for the EMT, accessible using the pen stylus and touch screen. For reference data the invention includes a drug reference database and a protocols database.

The invention facilitates free switching among different forms at any time. For example, if the EMT is recording billing information and the patient's vital signs abruptly change, the EMT may switch immediately from the Billing form to the Vitals form by giving only one signal to the interface (a single touch of the pen stylus to the Vitals button on the Billing form). The EMT then records any changes in vital signs. Returning to the Billing form is equally simple.

### Conclusion, Ramifications, and Scope of Invention

From the above descriptions, figures and narratives, the invention's advantages in collecting, storing and presenting medical emergency information should be clear.

Although the description, operation and illustrative material above contain many specificities, these specificities should not be construed as limiting the scope of the invention but as merely providing illustrations and examples of some of the preferred embodiments of this invention.

Thus the scope of the invention should be determined by the appended claims and their legal equivalents, rather than by the examples given above.

1. A computer program operated in a hand held computer for rapid, accurate, and economical gathering of medical emergency electronic data for emergency medical services, comprising:
a graphical user interface of the human body further comprising a first graphical representation of the human body, to simplify entry of all information gathered on an emergency medical call,
means for displaying graphical representations,
means for selecting data to be entered and stored from selections displayed on a screen, and
means for storage of entered data in the hand held computer.

2. The computer program of claim 1 wherein the graphical user interface of the human body further comprises graphical representations of one or more visible parts of the human body.

3. The computer program of claim 2 wherein the graphical representation of one or more visible parts of the human body further comprises a graphical representation of one or more visible parts of a female human body.

4. The computer program of claim 3 wherein the graphical representation of one or more visible parts of the human body further comprises a graphical representation of one or more visible parts of a male human body.

5. The computer program of claim 4 wherein the graphical user interface of the human body further comprises graphical representations of one or more orientations of visible parts of the human body.

6. The computer program of claim 5 wherein the graphical user interface of the human body further comprises means for selecting a graphical representation of a single visible part of the human body from a graphical representation of one or more visible parts of the human body.

7. The computer program of claim 6 wherein the means for selecting a graphical representation of a single visible part of the human body further comprises a software program for determining the location of a pen stylus on a touch sensitive screen.

8. The computer program of claim 6 wherein the graphical user interface of the human body further comprises means for selecting a graphical representation of a single orientation of a visible part of the human body from a graphical representation of one or more orientations of visible parts of the human body.

9. The computer program of claim 6 wherein the graphical user interface of the human body further comprises a computer program means for associating a graphical representation of a firs t human body part, having a selected second body part, with a graphical representation of the selected second body part.

10. The computer program of claim 9 wherein the graphical user interface of the human body further comprises a computer program means for associating a graphical representation of a first human body part, having a selected human body orientation, with a graphical representation of said first body part in the selected orientation.

11. The computer program of claim 10 wherein the graphical user interface of the human body further comprises a computer program means for replacing a graphical representation of a first human body part, having a selected second human body part, with a graphical representation of said selected human body part.

12. The computer program of claim 11 wherein the graphical user interface of the human body further comprises a computer program means for associating a graphical representation of a human body part with a stored identifying text.

13. The computer program of claim 12 wherein the graphical user interface of the human body further comprises one or more checklists of patient complaints.

14. The computer program of claim 13 wherein the graphical user interface of the human body further comprises means for selecting one or more patient complaints from the checklist.

15. The computer program of claim 14 wherein the graphical user interface of the human body further comprises one or more checklists of observed conditions.

16. The computer program of claim 15 wherein the graphical user interface of the human body further comprises means for selecting one or more observed conditions from the checklist.

17. The computer program of claim 16 wherein the means for selecting one or more patient complaints from the checklist further comprises a software program for determining the location of a pen stylus on a touch sensitive screen.

18. The computer program of claim 17 wherein the graphical user interface of the human body further comprises computer program means for associating the selected patient complaints with the stored identifying text.

19. The computer program of claim 18 wherein the graphical user interface of the human body further comprises computer program means for storing the selected patient complaints and the associated stored identifying text for later retrieval and use.

20. The computer program of claim 19 wherein the graphical representations of one or more orientations of visible parts of the human body further comprise a front view, a right side view, a left side view, and a rear view.

21. The computer program of claim 1 wherein the means for displaying graphical representations further comprises a software program for displaying graphical representations on a computer display screen.

22. The computer program of claim 1 wherein the graphical user interface of the human body further comprises one or more forms for entry of medical emergency information.

23. The computer program of claim 22 wherein each form further comprises:
an emergency call information header area,
a form selection area,
a form details area, and
a form paging area.

24. The computer program of claim 23 wherein the form selection area further comprises one or more buttons for selection of each form for display and use.

25. The computer program of claim 23 wherein the form details area further comprises an area for graphical representation of the human body.

26. The computer program of claim 25 wherein the form details area further comprises:
drop down pick lists of selection alternatives for single entry user selection,
radio buttons of selection alternatives for single entry user selection, and
check boxes of selection lists for single entry user selection for each choice required.

27. The computer program of claim 26 wherein the drop down pick lists further comprise drop down pick-lists for patient data entry, in which the items listed for selection vary based upon patient's age as previously entered.

28. The computer program of claim 22 wherein the forms further comprise:
one or more call forms for entry of information concerning an emergency medical call,
one or more billing forms for entry of billing information for the patient,
one or more problems forms for entry of details of the patient problem for which the emergency call was made and focal patient complaints,
one or more exam forms for entry of patient exam findings, and
one or more vitals forms for entry of patient vital signs.

29. The computer program of claim 28 wherein the problems form further comprises:
an emergency call information header area,
a form selection area,
a problem details area,
an area for graphical representations of parts of the human body, and
a form paging area.

30. The computer program of claim 29 wherein the problems form further comprises one or more motorized vehicle crash history forms for recording information about a motor vehicle crash involving the emergency medical patient.

31. The computer program of claim 28 wherein the vitals form further comprises one or more icons for rapid entry of normal vital sign and physical exam findings.

32. The computer program of claim 28 wherein the call form further comprises:
one or more quick entry icons for rapid entry of call event times,
a vehicle type drop down menu providing for single entry selection of an emergency vehicle type used,
a response drop down menu providing for single entry selection of a mode of response to the scene of the emergency, and
a call type drop down menu providing for single entry selection of a type of call.

33. The computer program of claim 32 wherein the vehicle type drop down menu further comprises:
an entry for ambulance,
an entry for helicopter,
an entry for airplane,
an entry for boat, and
an entry for other vehicle type.

34. The computer program of claim 28 wherein the graphical user interface further comprises:
one or more patient forms for entry of patient demographic information,
one or more past medical history forms for entry of information concerning a patient's past medical history, and
one or more patient medications forms for entry information concerning patient medications.

35. The computer program of claim 28 wherein the graphical user interface further comprises:
one or more treatment forms for entry of patient treatment by emergency medical technicians,
one or more disposition forms for entry of information concerning the disposition of the emergency call,
an integrated medical drug reference guide, and
a drug treatment form to facilitate rapid documentation of medication administration, routes and quantities.

36. The computer program of claim 28 wherein the graphical user interface further comprises:
one or more crew forms for entry of information concerning an emergency medical services crew,
one or more review forms for entry of review information concerning the emergency call,
one or more notes forms for entry of general notes,
one or more protocols forms for consulting protocols to be followed during the emergency call, and
one or more help screens for guiding emergency medical technicians on the use of the invention.

37. The computer program of claim 1 wherein the means for selecting data to be entered comprises a software program for determining the location of a pen stylus on a touch sensitive screen.

38. The computer program of claim 1 further comprising:
one or more software components supporting handwriting recognition,
one or more software components supporting numerical data entry,
one or more software components supporting signature capture, and
a software component for integrated signature capture for collection of required patient and crew signatures.

39. The computer program of claim 1 further comprising a software component for report printing via either wireless infrared transmission ports or standard serial cables to a variety of mutually compatible printers.

40. The computer program of claim 39 wherein the software component for report printing is capable of printing using a wireless infrared transmission port.

41. The computer program of claim 39 wherein the software component for report printing is capable of printing using a standard serial cable.

42. The computer program of claim 39 wherein the software component for report printing is capable of printing to a variety of mutually compatible printers.

43. The computer program of claim 1 further comprising a software component for transfer of medical emergency data to another computer system.

44. A single hand held computer system for gathering, retention, and transmission of emergency site electronic data for emergency medical services comprising:
a processor,
a main memory connected to the processor,
a storage subsystem connected to the processor for storage of medical reference guides and databases, and retention of medical emergency site electronic data,
a communications subsystem connected to the processor for transmission of medical emergency site electronic data,
a display subsystem connected to the processor and to the main memory, for displaying information to a user,
a touch sensitive screen connected to the display subsystem and to the processor, for allowing a user to select displayed information,
a pen stylus for selecting information displayed on a touch sensitive screen, and
computer program means stored and operated in the hand held computer for gathering, retaining and transmitting emergency site medical data.

45. The single hand held computer system of claim 44 further comprising a wireless infrared transmission port connected to the processor for communication with printers.

46. The single hand held computer system of claim 44 further comprising a standard serial cable connected to the processor for communication with printers.

47. The single hand held computer system of claim 44, wherein the computer program means further comprises:
means for generating an optional motorized vehicle crash history form for recording information about a motor vehicle carrying the emergency medical patient,
graphical user interface means for simplifying documentation of focal patient complaints and physical exam findings,
means for supporting handwriting recognition, signature capture and numerical data entry via the graphical user interface,
means for presenting a drug reference guide via the graphical user interface,
means for rapid entry via the graphical user interface of normal vital sign and physical exam findings,
means for flexible patient data entry via the graphical user interface based upon patient's age,
multilingual means for documenting via the graphical user interface a patient's refusal of care,
means for integrated signature capture via the graphical user interface for collection of required patient and crew signatures,
means for versatile report printing via either wireless infrared transmission ports or standard serial cables to a variety of mutually compatible printers, and
means for recording drug treatment via the graphical user interface to facilitate rapid documentation of medication administration, routes and quantities.

48. A method of gathering emergency site electronic data for emergency medical services comprising the steps of:
providing access to medical reference databases on a hand held computer using the computer's graphical user interface,
supporting a graphical user interface for entry and storage of emergency related information on the hand held computer,
retaining all emergency related information entered by the user during physical movement and storage of the hand held computer, and
transferring the emergency related information from the hand held computer to storage at the emergency treatment facility.

49. The method of gathering emergency site electronic data step of claim 48 wherein the step of supporting a graphical user interface for entry and storage of emergency related information further comprises the steps of
collecting emergency call related information from the user,
collecting patient related information from the user,
collecting medical problem related information from the user,
collecting vital signs information from the user,
collecting treatment information from the user, and
collecting billing information from the user.

50. The method of gathering emergency site electronic data step of claim 49 wherein the step of collecting emergency call related information from the user further comprises:
presenting to the user one or more forms requesting the entry of emergency call related information, and
storing in mass storage the emergency call related information submitted by the user.

51. The method of gathering emergency site electronic data of claim 49 wherein the step of collecting patient related information further comprises the steps of:
presenting to the user one or more forms requesting the entry of patient prior medical history information,
storing in mass storage the patient prior medical history information submitted by the user,
presenting to the user one or more forms requesting the entry of patient medications information,
storing in mass storage the patient medications information submitted by the user,
presenting to the user one or more forms requesting the entry of patient examination information, and
storing in mass storage the patient examination information submitted by the user.

52. The method of gathering emergency site electronic data of claim 49 wherein the step of collecting medical problem related information further comprises the steps of
collecting motor vehicle crash information from the user, and
collecting patient complaint information from the user.

53. The method of gathering emergency site electronic data of claim 52 wherein the step of collecting motor vehicle crash information further comprises the steps of
presenting to the user one or more forms requesting the entry of motor vehicle crash information, and
storing in mass storage the motor vehicle crash information submitted by the user.

54. The method of gathering emergency site electronic data of claim 52 wherein the step of collecting patient complaint information further comprises the steps of
displaying a graphical representation of one or more parts of the human body,
accepting a selection by the user of an affected part of the human body,
associating the selection of the affected part of the body with the graphical representation of that affected part of the body,
storing in mass storage the designation of the affected part of the body,
collecting the complaints reported by the patient for the affected part of the body,
collecting patient symptoms observed by the user for the affected part of the body, and
storing in mass storage the patient complaints and observed symptoms.

55. The method of gathering emergency site electronic data of claim 49 wherein the step of collecting vital signs information further comprises the steps of:
presenting to the user one or more forms requesting the entry of vital signs information, and
storing in mass storage the vital signs information submitted by the user,

56. The method of gathering emergency site electronic data of claim 49 wherein the step of collecting treatment information further comprises the steps of:
presenting to the user one or more forms requesting the entry of treatment information, and
storing in mass storage the treatment information submitted by the user,

57. The method of gathering emergency site electronic data of claim 49 wherein the step of collecting billing information further comprises the steps of:
presenting to the user one or more forms requesting the entry of billing information, and
storing in mass storage the billing information submitted by the user.

58. The method of gathering emergency site electronic data of claim 49 further comprising the step of collecting background information from the user,

59. The method of gathering emergency site electronic data of claim 58 wherein the step of collecting background information further comprises the steps of:
presenting to the user one or more forms requesting the entry of background information, and
storing in mass storage the background information submitted by the user.

60. The method of gathering emergency site electronic data of claim 58 wherein the background information further comprises:
emergency crew related information,
patient disposition information,
case review information, and
notes.

61. The method of gathering emergency site electronic data of claim 48 wherein the step of providing access to medical reference databases further comprises the step of providing access to a medical drug reference guide.

62. The method of gathering emergency site electronic data of claim 48 wherein the step of providing access to medical reference databases further comprises the step of providing access to a medical protocols database.
